(19) United States
(12) Patent Application Publication
(10) Pub. No.: US 2009/0127886 A1
(43) Pub. Date: May 21, 2009

(54) ACCESS DOOR FOR TRUCK BEDS

(76) Inventor: Brent Stortzum, Dieterich, IL (US)

Correspondence Address: MICHAEL BERNS;MALONEY, PARKINSON AND BERNS, 135 W MAIN STREET, URBANA, IL, 61801, US

(21) Appl. No.: 12/275,045

(22) Filed: Nov. 20, 2008

Related U.S. Application Data
(60) Provisional application No. 60/989,217, filed on Nov. 20, 2007.

(51) Int. Cl. B60J 5/04

(52) U.S. Cl. 296/146.1

(57) ABSTRACT

A pickup truck having a door panel in the side of the bed to allow access to the bed area. A door provides helpful entry into the bed area to connect a trailer, secure items, utilize greater storage, or other reasons.

### CROSS-REFERENCE TO RELATED APPLICATION

This application claims the benefits of the earlier filed U.S. Provisional App. Ser. No. 60/989,217, filed Nov. 20, 2007, which is incorporated by reference for all purposes into this application.

### BACKGROUND OF THE INVENTION

The invention relates to an access door to a pickup truck. Prior art was discovered where other patents have had some access to the truck bed through the sidewall.

U.S. Pat. No. 7,219,941, U.S. Pat. No. 5,188,414, U.S. Pat. No. 4,861,096, and U.S. Pat. No. 6,499,795 disclose variations on the concept. None of these provides an access door such as described in the present invention, to gain access to the inside of the bed area in the same manner.

### SUMMARY OF THE INVENTION

The concept of this invention is to allow an individual an alternative access to a pickup truck bed without reaching over the sides, climbing on the rear tires or entry through the tailgate and climbing over cargo in the rear of the bed storage area.

Pickup trucks with the standard beds are used to haul varieties of different items and are used for many different purposes through there service life. Many times the items the user is hauling are many shapes, sizes, configurations with placement in the bed being crucial for accessibility, convenience and safety. Many times small items migrate to the front of the bed during transport or other times the user wants the lighter items that could possibly blow out to be placed in the front of the bed. The user could be towing a fifth wheel trailer or a bumper hitch trailer and is unable to lower the tailgate to gain entry into the bed storage area or they do not want to climb over all of the items in the bed.

There is a great necessity for another access into a bed to make pickup trucks more adept for today's growing need and versatility of the user's preferences. Truck bed accessories and attachments are a huge market for adding different varieties of uses of a truck bed. This door complements these accessories by making it more versatile in using the entire bed area and making the user more productive.

This invention provides an access door to gain access to the bed area of a truck. The access door of the invention could be used for numerous tasks, or to make common tasks less difficult for the user. The following list are some of the many uses the access door of the invention could provide:

1. The door could provide access to someone hooking or unhooking a fifth wheel or gooseneck trailer.

2. The door would assist in placing cargo in the bed of truck without lifting items over the side of the bed when the trailer is hooked up and in the way of the rear tailgate access.

3. The door could be used in conjunction with a set of drawers to slide out when the access door was opened.

4. A wheelchair could be placed into the truck bed through the access door, rather than the need to lift it over the pickup bed sidewalls, or through the tailgate.

5. The door could be used in combination with any camper shell topper on the market today for additional access to the front of the truck bed area. With toppers attached over the top of the bed, it is difficult to get to the front area to use for storage.

6. The door could be used with ladder racks or cargo racks.

7. If a bed cover, such as a tonneau cover, was placed on the bed it still would allow the owner access to the front of the truck bed without compromising the purpose for the truck bed cover.

It is an object of the invention to provide access to the truck bed through the sidewall of the truck and provide an access way to satisfy some of these ongoing needs.

### DESCRIPTION OF THE DRAWINGS

FIG. 1 is an oblique view of a pickup truck utilizing an access door embodiment of the invention.

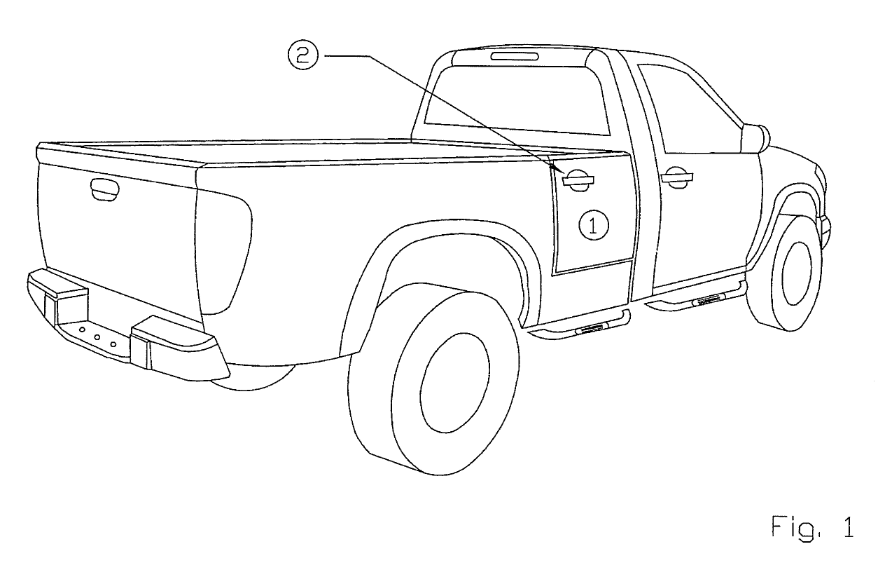

FIG. 2 is an oblique view of a pickup truck utilizing an access door embodiment of the invention, with the door open.

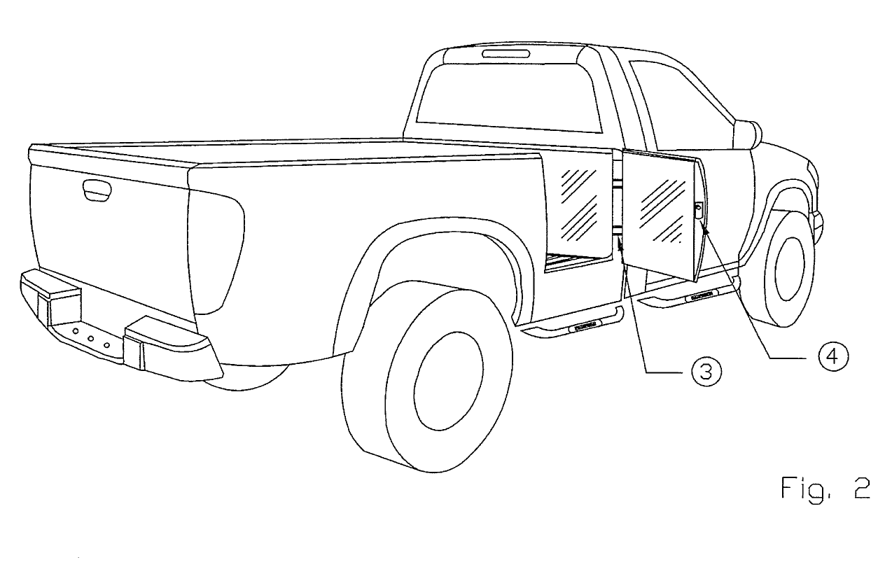

FIG. 3 is an oblique view of a pickup truck utilizing an access door embodiment of the invention, with the door open, pulling a fifth wheel trailer.

FIG. 4 is an oblique view of a pickup truck utilizing an access door embodiment of the invention, with the door open, with a bed cover enclosure on the pickup truck bed.

FIG. 5 is an oblique view of a pickup truck utilizing an access door embodiment of the invention, with the door open, with a utility rack over the pickup truck bed.

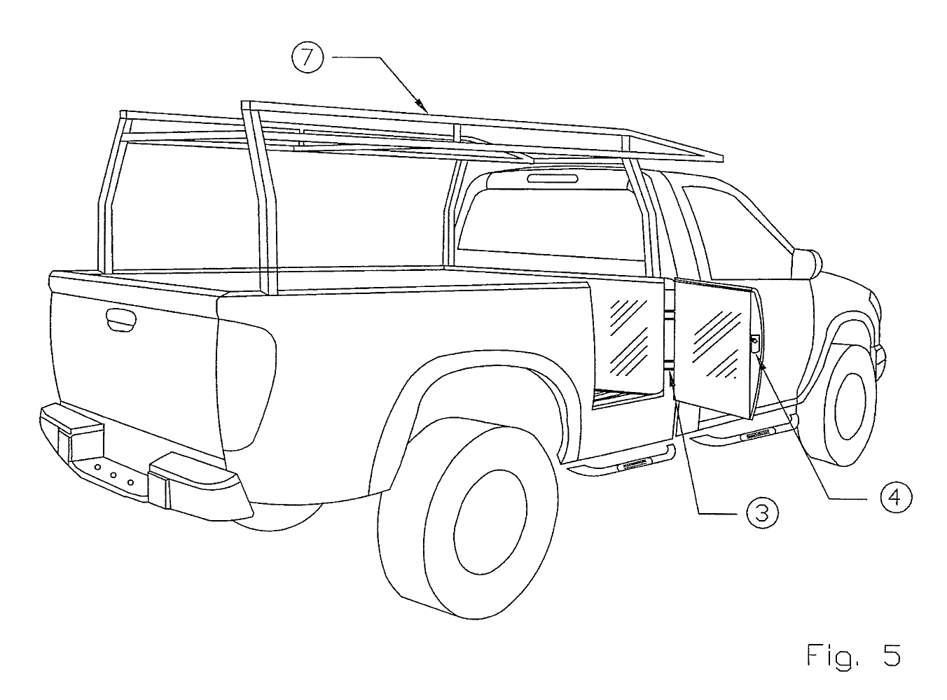

FIG. 6 is an oblique view of a pickup truck utilizing an access door embodiment of the invention, with the door open, with a bed topper enclosure over the pickup truck bed.

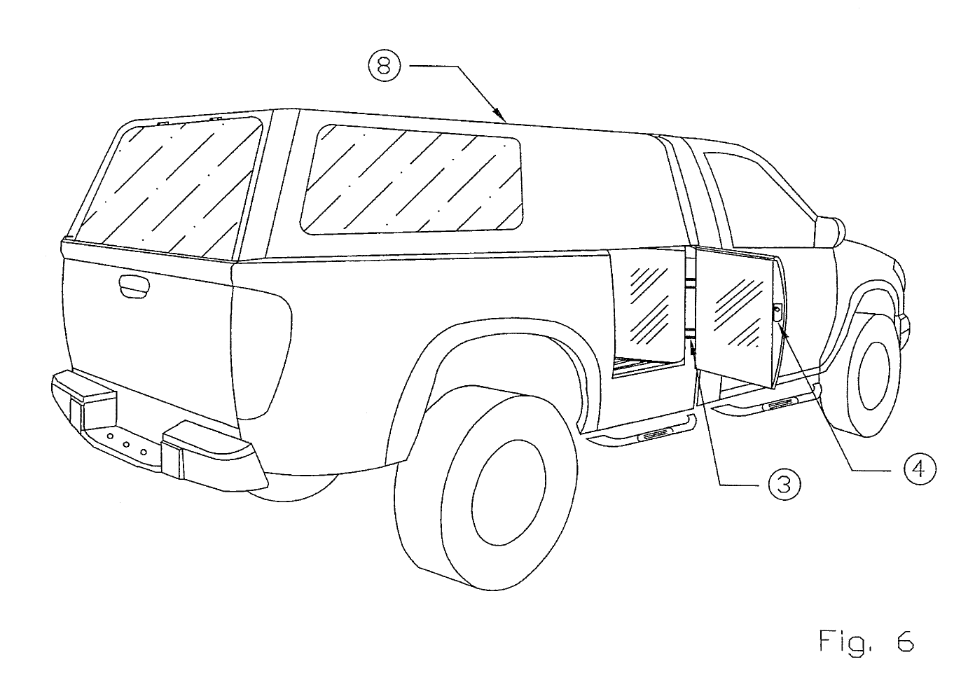

FIG. 7 is a series of cross-section views of a door of the invention.

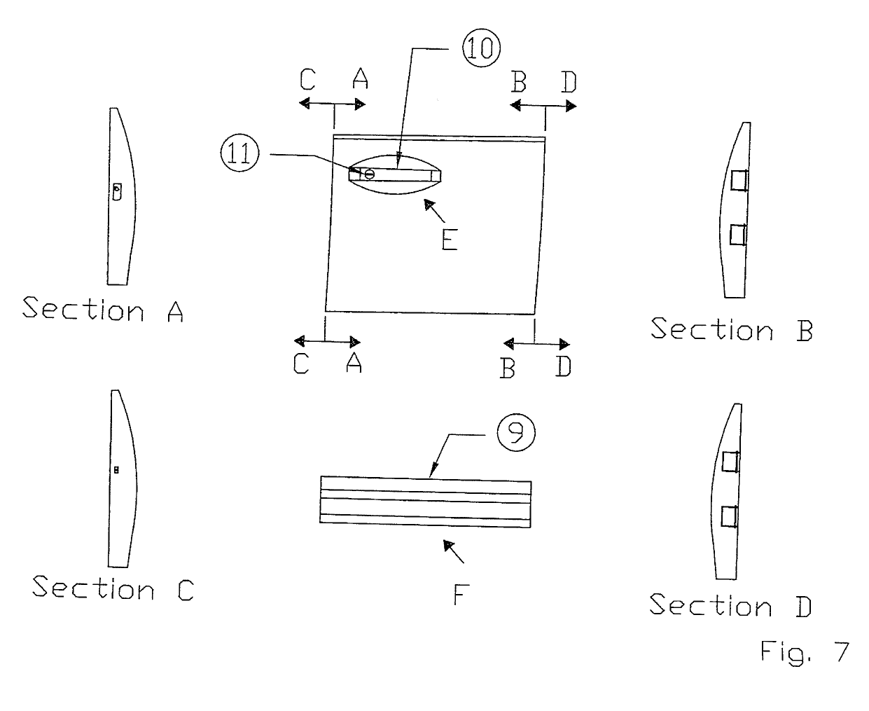

### DETAILED DESCRIPTION OF THE INVENTION

The preferred embodiment shown in the figures is an example of an access way into a truck bed area that could be accessed from the side of the vehicle.

A door 1, or similar access way, is provided to be mounted in the sidewall of a pickup truck bed, preferably a fleet side type standard pickup bed. The door 1 could be placed in either a long bed or short bed version. A door 1 could be located on any corner or portion of bed depending on make, model, or year of truck.

The access door 1 of the invention would provide access to the truck bed for numerous reasons or purposes. This may be of particular benefit to those trucks pulling fifth-wheel trailers that extend into the bed of the truck.

The door 1 could be provided to match the lines and design of the existing truck body exterior surface, such that it would blend into the design of the vehicle. The door 1 could be hinged either vertically or horizontally off existing bed side walls. The top of the door 1 would preferably be flush with the top of bed and the bottom of door access area could stop at the floor of bed or continue to the bottom of the body cavity. A door handle 2 or latch mechanism would need to be added for secured closure when truck was in motion and would be able to open when needing access to bed area. The handle 2 or latch could match the existing trucks other latches or handles to give a nice uniform look or other useful latches could be used. There also could be a latch mounted to the inside of door 1 to give egress to someone exiting the bed area. The door 1 could also be equipped with standard automotive door locks 11 or even electric door locks to secure contents in bed when a truck shell topper 8 or bed cover 6 application was in use.

Additional simplicity for someone entering the bed of the truck would be to add a truck accessory like a extended running boards or nerf bars that would assist in stepping up into the truck bed. One possible step option is to make a step that is molded into the floor of the bed but extended down a portion to act as a step when the door 1 was opened, if the door 1 was made to open entirely to the bottom cavity of the body.

The side of the truck bed where the access door 1 would be located may need to be reinforced for the support of the addition of access door hinges 3. The doorjamb could be similar or based on the same principle of the other door jambs for entering the truck cab or tailgate. If perhaps the access door 1 would hinge horizontally, the jamb could resemble the tailgate latching system. With the embodiment of the invention shown in the figures installed in the side of a pickup truck bed, the truck would still look virtually the same as if it was not installed. The aerodynamics of the truck would have very little change or have the same effect as if not installed. The truck bed storage capacity would not be compromised by the proposed access door 1. There appears to be no reason why any truck accessory on the market today would not still be usable for the truck bed setup proposed. With this access door 1 placed in the truck bed side it would make the truck cargo area much more versatile in what and how something could be stowed or placed within the dimensions of the bed.

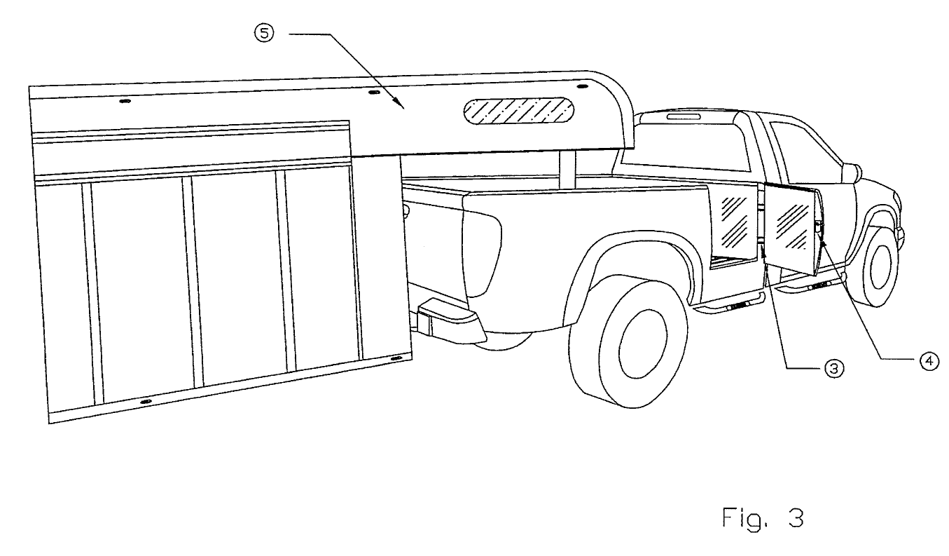

As shown in FIG. 3, the access door 1 of the invention would be particularly useful in gaining access to the pickup truck bed when using a fifth wheel trailer 5. Connection for these trailers requires some alignment, which can be seen and connected by entering into the pickup truck bed through the access door 1, rather than climbing over the side.

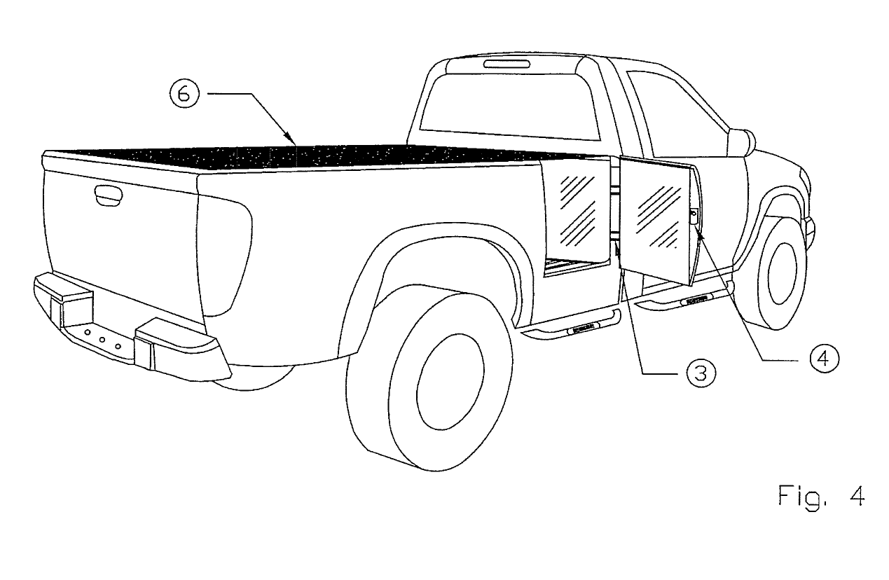

As shown in FIG. 4, when using a pickup truck bed cover 6, the access door 1 also provides improved access to the bed area. Some bed covers raise to allow access from the top, but many only allow access through the tailgate. By providing access to the front of the pickup truck bed, near the cab area, additional usage is gained.

Similarly, other pickup truck accessories, such as a utility rack 7 or a shell topper 8 restrict access that is improved through the present invention.

The access door could also be featured with minor enhancement accessories such as:
1. A pocket could be placed on the inside of door 1 for tools or other items.
2. Marking lights could be added to make the access door 1 visible in dark situations when open, illuminating the access door, access door frame, or ground beneath the access door.
3. Electric door locks could be added to work in conjunction with other door locks of the vehicle to make securing your cargo more convenient when bed cover 6 or truck topper 8 is in use.

In installing an access door 1 into an existing pickup truck, the side wall of the pickup truck bed would be cut open to the proper size, then a door frame could be installed into the side wall. The access door 1 would then be installed with the An after-market kit with the necessary parts and information could be sold to installers.

An access door 1 mounted in the side wall of a cargo bed attached to a pickup truck having conventional cab body and frame is commonly known. The cargo bed which this is referring to has two sidewalls on either side with a front wall up next to the cab and a tailgate on the rear of the bed. Placement of the access door 1 is located between the fender well and the front wall of the bed with the direction of the access door 1 swinging out, away from the bed in the same manner as a cab door. When retro-fitting the placement of the access door 1 in the sidewall of a pickup truck bed it is preferred not to manipulate the stake pockets located in the top rail of the bed wall and the fender well itself, but to stay within the uniform portion of the bed side in between the critical components.

Placement of the access door 1 in various makes and models will differ in the dimensions used for placement of the access door 1. The same as the door the mounting plates, hinges 3 and latches 4 will differ from the various models. As future pickup truck models continue to evolve, the dimensions for the access door 1 illustrated in the figures will change, but the overall concept of the invention will not change from the original scope.

While particular element, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

I claim:

1. A pickup truck comprising:
a frame;
a pickup bed having side walls mounted on top of the frame;
a hinged door located in the side wall of the pickup bed for passenger access to the bed between the side walls;
a door frame mounted in the side wall of the pickup bed.

2. The pickup truck according to claim 1, wherein the door includes a latch to selectively secure the door in the door frame.

3. A method of providing access to a pickup truck bed comprising:
cutting through a sidewall of a pickup truck bed;
installing a door frame into the sidewall;
installing a door in the door frame.
